(19) United States
(12) Patent Application Publication
(10) Pub. No.: US 2005/0050534 A1
(43) Pub. Date: Mar. 3, 2005

(54) Methods and apparatus to pre-execute instructions on a single thread

(76) Inventors: Chi-Keung Luk, Shrewsbury, MA (US); Paul Lowney, Concord, MA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/653,602

(22) Filed: Sep. 2, 2003

(51) Int. Cl. G06F 9/45

(52) U.S. Cl. 717/159

(57) ABSTRACT

Methods and apparatus to pre-execute instructions on a single thread are disclosed. In an example method, at least one instruction associated with a latency condition is identified. A slice of instructions is identified. The slice of instructions is configured to generate a data address associated with the at least one instruction. At least one instruction slot in the single thread is identified. Code configured to execute the slice of instructions is generated within the at least one instruction slot.

### TECHNICAL FIELD

The present disclosure relates generally to compilers, and more particularly, to methods and apparatus to pre-execute instructions on a single thread.

### BACKGROUND

In an effort to improve and optimize performance of processor systems, many different pre-fetching techniques (i.e., anticipating the need for data input requests) are used to remove or “hide” latency (i.e., delay) of processor systems. In particular, pre-fetch algorithms (i.e., pre-execution or pre-computation) are used to pre-fetch data for cache misses associated with data addresses that are difficult to predict during compile time. That is, a compiler first identifies the instructions needed to generate data addresses of the cache misses, and then speculatively pre-executes those instructions. Typically in most pre-fetch algorithms, pre-execution of instructions is performed on separate threads (i.e., multi-thread) while normal execution is performed on the main thread. In particular, a thread is information needed to serve a particular service request. For example, a thread is created when a program initiates an input/output (I/O) request such as reading a file or writing to a printer. The data kept as part of the thread allows a processor to reenter at the proper place of the program when the I/O operation is completed. Although most pre-fetch approaches are particularly well-suited for multi-thread processor systems, they may not be suitable for single-thread processor systems.

### BRIEF DESCRIPTION OF THE DRAWINGS

FIG. 1 is a block diagram representation of an example processor system.

FIG. 2 is a block diagram representation of an example single-thread pre-execution system.

FIG. 3 is a diagram representation of an example set of code.

FIG. 4 is a diagram representation of the example set of code shown in FIG. 3 with pre-execution code.

FIG. 5 is a flow diagram representation of example machine readable instructions that may pre-execute instructions on a single thread.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

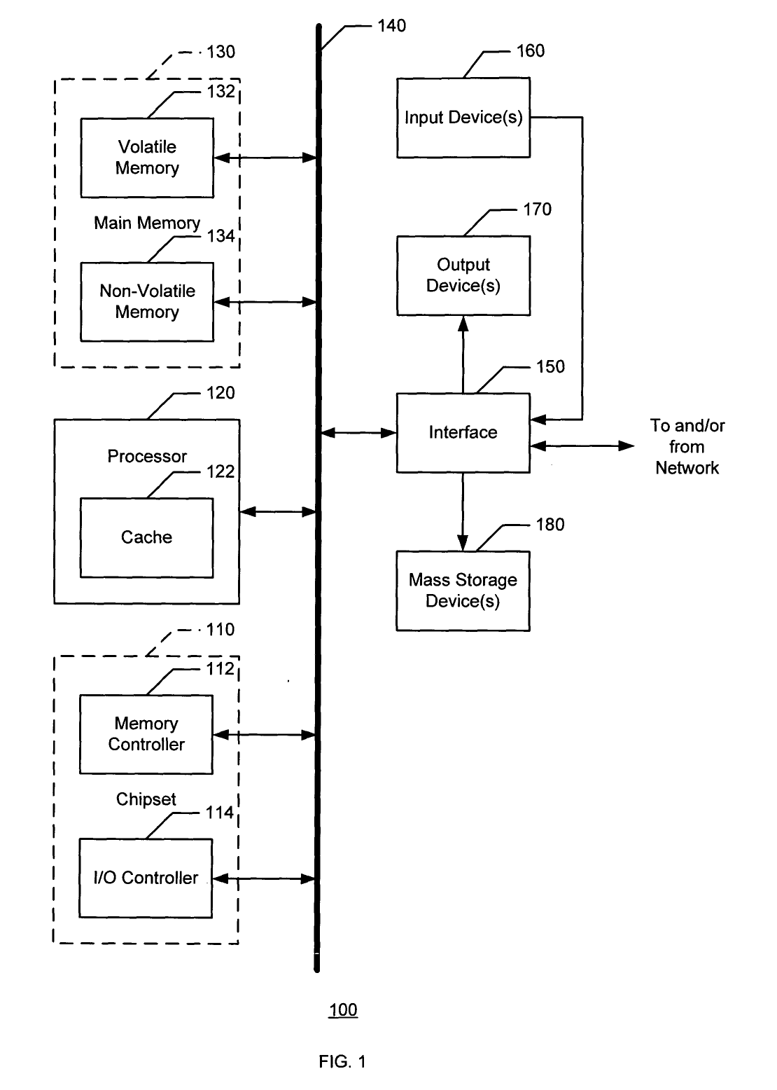

FIG. 1 is a block diagram of an example processor system 100 adapted to implement the methods and apparatus disclosed herein. The processor system 100 may be a desktop computer, a laptop computer, a notebook computer, a personal digital assistant (PDA), a server, an Internet appliance or any other type of computing device.

The processor system 100 illustrated in FIG. 1 includes a chipset 110, which includes a memory controller 112 and an input/output (I/O) controller 114. As is well known, a chipset typically provides memory and I/O management functions, as well as a plurality of general purpose and/or special purpose registers, timers, etc. that are accessible or used by a processor 120. The processor 120 is implemented using one or more processors. For example, the processor 120 may be implemented using one or more of the Intel® Pentium® family of microprocessors, the Intel® Itanium® family of microprocessors, Intel® Centrino® family of microprocessors, and/or the Intel XScale® family of processors. In the alternative, other processors or families of processors may be used to implement the processor 120. The processor 120 includes a cache 122, which may be implemented using a first-level unified cache (L1), a second-level unified cache (L2), a third-level unified cache (L3), and/or any other suitable structures to store data as persons of ordinary skill in the art will readily recognize.

As is conventional, the memory controller 112 performs functions that enable the processor 120 to access and communicate with a main memory 130 including a volatile memory 132 and a non-volatile memory 134 via a bus 140. The volatile memory 132 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 134 may be implemented using flash memory, Read Only Memory (ROM), Electrically Erasable Programmable Read Only Memory (EEPROM), and/or any other desired type of memory device.

The processor system 100 also includes an interface circuit 150 that is coupled to the bus 140. The interface circuit 150 may be implemented using any type of well known interface standard such as an Ethernet interface, a universal serial bus (USB), a third generation input/output interface (3GIO) interface, and/or any other suitable type of interface.

One or more input devices 160 are connected to the interface circuit 150. The input device(s) 160 permit a user to enter data and commands into the processor 120. For example, the input device(s) 160 may be implemented by a keyboard, a mouse, a touch-sensitive display, a track pad, a track ball, an isopoint, and/or a voice recognition system.

One or more output devices 170 are also connected to the interface circuit 150. For example, the output device(s) 170 may be implemented by display devices (e.g., a light emitting display (LED), a liquid crystal display (LCD), a cathode ray tube (CRT) display, a printer and/or speakers). The interface circuit 150, thus, typically includes, among other things, a graphics driver card.

The processor system 100 also includes one or more mass storage devices 180 configured to store software and data. Examples of such mass storage device(s) 180 include floppy disks and drives, hard disk drives, compact disks and drives, and digital versatile disks (DVD) and drives.

The interface circuit 150 also includes a communication device such as a modem or a network interface card to facilitate exchange of data with external computers via a network. The communication link between the processor system 100 and the network may be any type of network connection such as an Ethernet connection, a digital subscriber line (DSL), a telephone line, a cellular telephone system, a coaxial cable, etc.

Access to the input device(s) 160, the output device(s) 170, the mass storage device(s) 180 and/or the network is typically controlled by the I/O controller 1 14 in a conventional manner. In particular, the I/O controller 114 performs functions that enable the processor 120 to communicate with the input device(s) 160, the output device(s) 170, the mass storage device(s) 180 and/or the network via the bus 140 and the interface circuit 150.

While the components shown in FIG. 1 are depicted as separate blocks within the processor system 100, the functions performed by some of these blocks may be integrated within a single semiconductor circuit or may be implemented using two or more separate integrated circuits. For example, although the memory controller 112 and the I/O controller 114 are depicted as separate blocks within the chipset 110, persons of ordinary skill in the art will readily appreciate that the memory controller 112 and the I/O controller 114 may be integrated within a single semiconductor circuit.

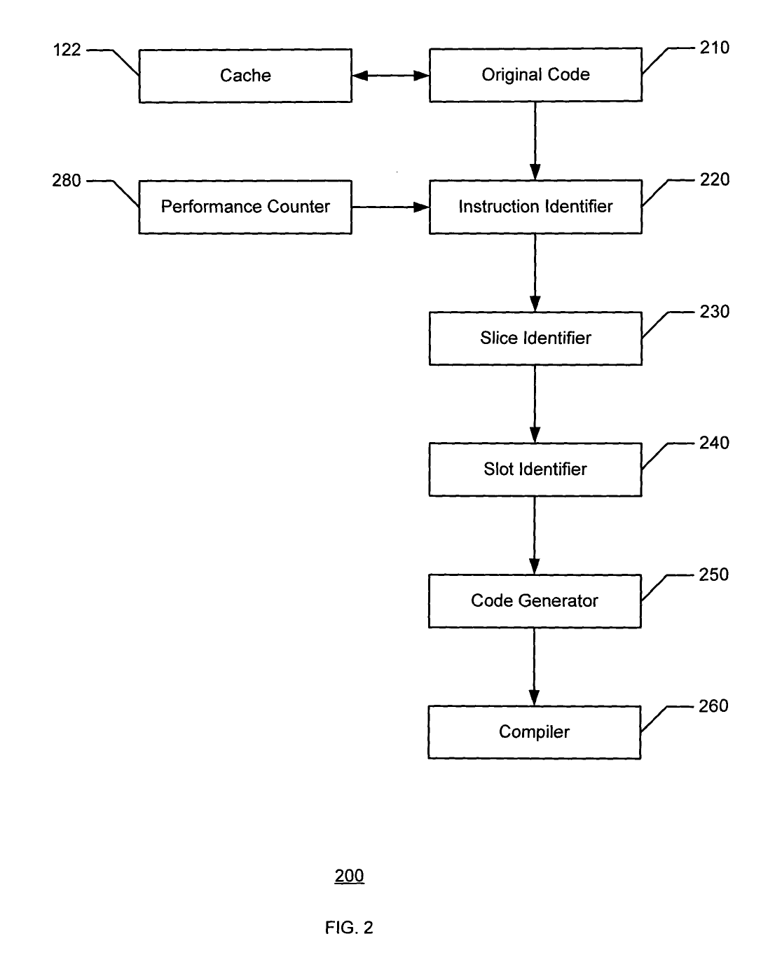

In the example of FIG. 2, the illustrated single-thread pre-execution system 200 includes an original code 210, an instruction identifier 220, a slice identifier 230, a slot identifier 240, a code generator 250, a compiler 260, a cache 270, and a performance counter 280. The single-thread pre-execution system 200 may be implemented using the processor 120 described above to optimize the original code 210. In general, the processor 120 identifies an instruction associated with a latency condition, which delays the operation or increases the response time of the processor system 100 described above. To remove or “hide” the latency, the processor 120 generates and inserts code within the original code 210 to pre-execute instructions needed by the instruction associated with the latency condition.

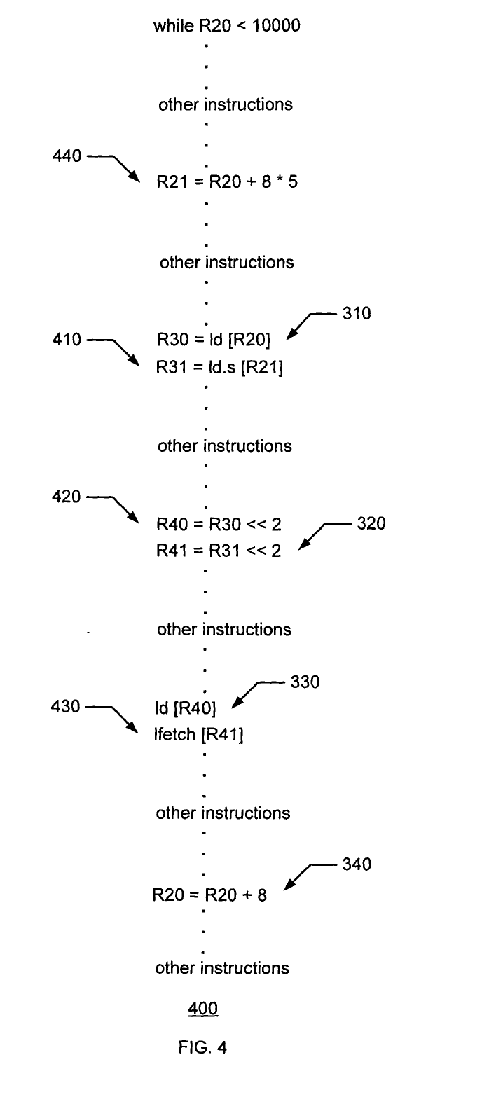

The original code 210 (e.g., described in detailed below and shown as 400 in FIG. 4) includes one or more instructions configured to load a value from a data address (i.e., a load instruction), store a value into a data address (i.e., a store instruction), serve as a placeholder for another instruction (i.e., an instruction that specify no operation), and/or any other suitable commands to execute an application. As used herein “application” refers to one or more functions, routines, and/or subroutines for manipulating data.

The instruction identifier 220 is configured to identify one or more instructions associated with a latency condition(s) in the original code 210. That is, one or more instructions associated with the latency condition(s), such as one or more instructions associated with cache misses, which are requests by code to read from memory that cannot be satisfied from the cache 270 (e.g., one shown as 122 in FIG. 1). Referring to FIG. 1, for example, a load instruction may request to read a data address from the cache 122. When the data address is not stored in the cache 122, the main memory 140 is consulted to address the requests. Because the processor 120 retrieves the data address associated with the load instruction from the main memory 140 rather than the cache 122, a delay occurs when that load instruction is executed (i.e., a load latency).

Referring back to FIG. 2, the instruction identifier 220 may use load-latency profiling to determine whether a particular instruction is associated with a latency condition. For example, the instruction identifier 220 may use the performance counter 280 to determine how often a cache miss occurs when a particular instruction is executed. Based on the performance information provided by the performance counter 280 (e.g., the number of cache misses associated with an instruction), an instruction is identified as a latency instruction (i.e., instruction associated with the latency condition) if the number of cache misses exceeds a threshold when the instruction is executed. Alternatively, statistics on performance from simulations may also be implemented to conduct load-latency profiling as persons of ordinary skill in the art will appreciate.

After a latency instruction has been identified, the slice identifier 230 is configured to identify a slice (i.e., a collection) of instructions associated with the latency instruction. In particular, the slice of instructions includes one or more instructions configured to generate a data address associated with the latency instruction. The data address may be stored in a register and/or any other data structure that passes data from one or more instructions and/or programs to another. Because the data addresses associated with the slice of instructions are dependent on the data address associated with the latency instruction, a group of one or more instructions are identified as the slice.

In general and as described in detail below, the slice identifier 230 starts with identifying an innermost loop associated with the latency instruction. While the methods and apparatus disclosed herein are particularly well suited to identify the innermost loop, persons of ordinary skill in the art will appreciate that the teachings of the disclosure may be applied to identify an outer loop associated with the latency instruction as well.

Within the innermost loop, the slice identifier 230 identifies a base register (i.e., the register of the first instruction of the slice), and tracks backward to identify other registers associated with the base register until it identifies a register that holds an induction variable (e.g., i=i+1), a recurrent load (e.g., p=p→next), or a loop invariant register. In particular, an induction variable increments or decrements by a constant every time the variable changes value. For example, a recurrent load produces a data address consumed by future instances of that data address itself. Recurrent loads are typically used as induction variables in loops. As noted above, the slice identifier 230 also stops tracking for other registers when it identifies an instruction associated with a register that is loop invariant within the loop (i.e., constant).

The slice of instructions may be pre-executed by a number of iterations to compensate for stall cycles associated with the cache. That is, the induction variable or the recurrent load of the loop may be adjusted to include a pre-execution distance so that the slice of instructions is pre-executed. As an example, for a latency instruction associated with a cache having two stall cycles, the induction variable or the recurrent load may be set so that the slice of instructions is pre-executed two cycles ahead. The pre-execution distance may be pre-set and/or calculated to compensate for the stall cycles.

The slot identifier 240 is configured to identify computation resources available to pre-execute the slice of instructions responsible for latency. In particular, the slot identifier 240 identifies one or more instruction slots within the original code 210 where one or more code configured to execute the slice of instructions (i.e., pre-execution code) may be inserted as described in detail below. For example, the original code 210 may include “no ops” (i.e., instructions that specify no operation), which serve as placeholders that may be replaced by the pre-execution code. Alternatively, the original code 210 may include instruction slots in dynamic form (e.g., stalled cycles) rather than in static form as in explicit “no ops.” The compiler 260 is configured to identify the instruction slots in dynamic form within the original code 210.

The code generator 250 is configured to generate the pre-execution code, the goal of which is to reduce latency associated with cache misses. In particular, the pre-execution code may include instructions that utilized different registers than the original code 210 to avoid corrupting register values (e.g., data addresses) in registers associated with the original code 210. Based on whether the result of a load instruction in the slice is required to continue the pre-execution, a speculative load (e.g., ld.s) or a pre-fetch (e.g., 1fetch) instruction(s) corresponding to that load instruction may be generated in the pre-execute code as described in detail below. In general, the pre-execution code produced by the code generator 250 is inserted into the instruction slots identified by the slot identifier 240 so that the compiler 260 may pre-execute the latency instruction on a single thread.

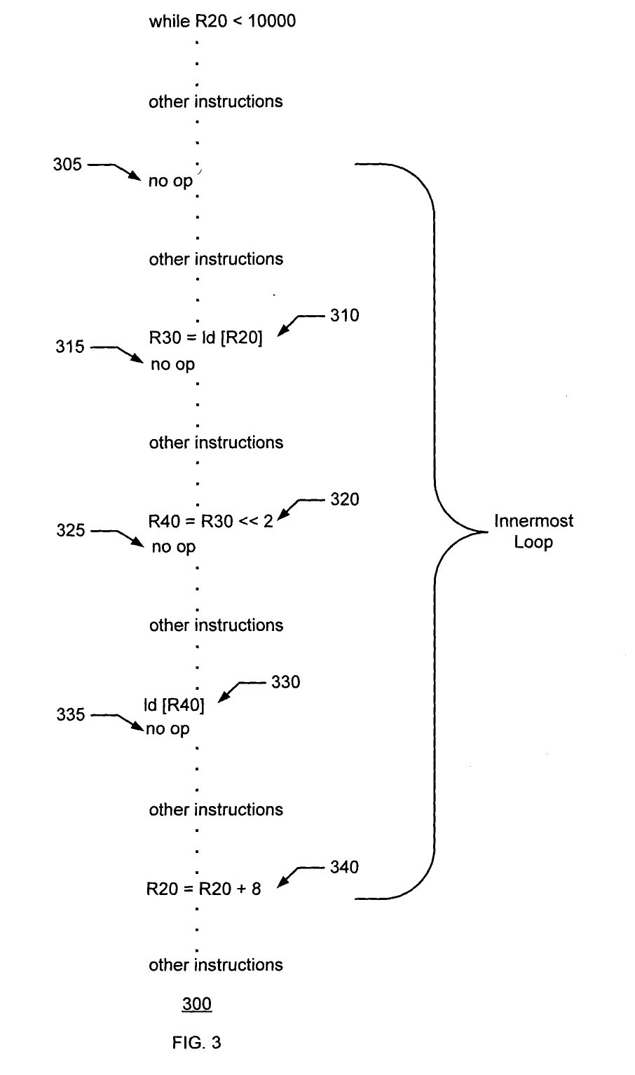

In the example of FIG. 3, the illustrated set of code 300 includes a plurality of instructions (generally shown as 310, 320, 330, and 340), a plurality of no ops (generally shown as 305, 315, 325, and 335) and other instructions. While instruction slots in the set of code 300 shown in FIG. 3 are depicted as the plurality of no ops 305, 315, 325, 335, persons of ordinary skill in the art will readily appreciate that the instruction slots may be in dynamic form identified by the compiler 260 (e.g., stalled cycles). To illustrate the concept of pre-executing an instruction on a single thread, the load instruction 330 (i.e., load [R40]) is identified as an instruction associated with a latency condition based on load-latency profiling as described above. Within an innermost loop, a slice of instructions configured to generate a data address associated with the load instruction 330 are identified. To identify the slice of instructions, one or more registers are identified in a reverse fashion starting from a base register of the load instruction 330 (i.e., register R40). The slice of instructions include instructions up to an instruction associated with a register that is either an induction variable (e.g., i=i+1) or a recurrent load (e.g., p=p→next). Alternatively, the slice of instructions includes instructions up to an instruction associated with a register that is invariant within the loop (i.e., constant). For example, the base register for the load instruction 330 is register R40. Instruction 320 includes register R40, which is based on register R30. Instruction 310 includes register R30, which in turns, is based on register R20. Instruction 340 includes register R20, which is an induction variable of the set of code 300. That is, register R20 increments by a constant of eight (8) every time that it changes value with the innermost loop. Accordingly, instructions 310, 320, and 340 are included in the slice of instructions associated with the load instruction 330 because registers R20 and R30 are dependent on R40.

As noted above, the original set of code 300 includes a plurality of no ops 305, 315, 325, and 335. The no ops serve as placeholders within the original set of code 300 where the pre-execution code (i.e., code configured to execute the slice of instructions) may be inserted. In the example of FIG. 4, the illustrated set of code 400 includes pre-execution code, generally shown as instructions 410, 420, 430, and 440. In particular, the instructions 410, 420, 430, and 440 replace the no ops 305, 315, 325, and 335 of the original set of code 300, respectively. To avoid corrupting register values of the original set of code 400, the pre-execution code (i.e., instructions 410, 420, 430, and 440) is generated with different registers to store data addresses. In particular, instructions 310, 320, 330, and 340 of the original set of code 300 use registers R20, R30, and R40 while instructions 410, 420, 430, and 440 of the set of code 400 use registers R21, R31, and R41. Also noted above, the original set of code 300 may include instruction slots in dynamic form as in stalled cycles rather than instruction slots in static form as in no ops. Accordingly, the compiler 260 may identify the stalled cycles in the original set of codes 300 and replace the stalled cycles with the pre-fetch instructions.

The code generator 250 generates either a speculative load (i.e., ld.s) or a pre-fetch (i.e., 1fetch) corresponding to each load instruction based on whether the load result of that load instruction is required to continue the pre-execution of the latency instruction 330. For example, instruction 430 (i.e., 1fetch [R41]) is generated as a pre-fetch instruction to correspond to the load instruction 330 (i.e., ld [R40]) because the value of register R41 is not dependent on the load result of the instruction 430 (i.e., the data address associated with register R41 is simply loaded). In another example, instruction 410 (i.e., R31=ld.s [R21]) is generated as a speculative load instruction to correspond to the load instruction 310 (i.e., R30=Id [R20]) because the load result of the load instruction 410 (i.e., register R31) is required to continue the pre-execution. That is, the value of register R31 is required to determine the value of register R41 in the instruction 420 (i.e., instruction 420 is dependent on instruction 410).

Further, the induction variable or the recurrent load includes a pre-execution distance (i.e., a number of iterations) to avoid the cache miss latency of the load instruction 330. Accordingly, the value of register R41 is determined before it is needed. In instruction 440 (i.e., R21=R20+8*5), for example, the pre-execution distance is five. That is, the induction variable of eight is multiplied by five so that the pre-execution code (i.e., code to execute instructions 410, 420, 430, and 440) is executed five iterations prior to when the value of register R41 is needed. As a result, the compiler 270 may pre-fetch data associated with cache misses on a single thread.

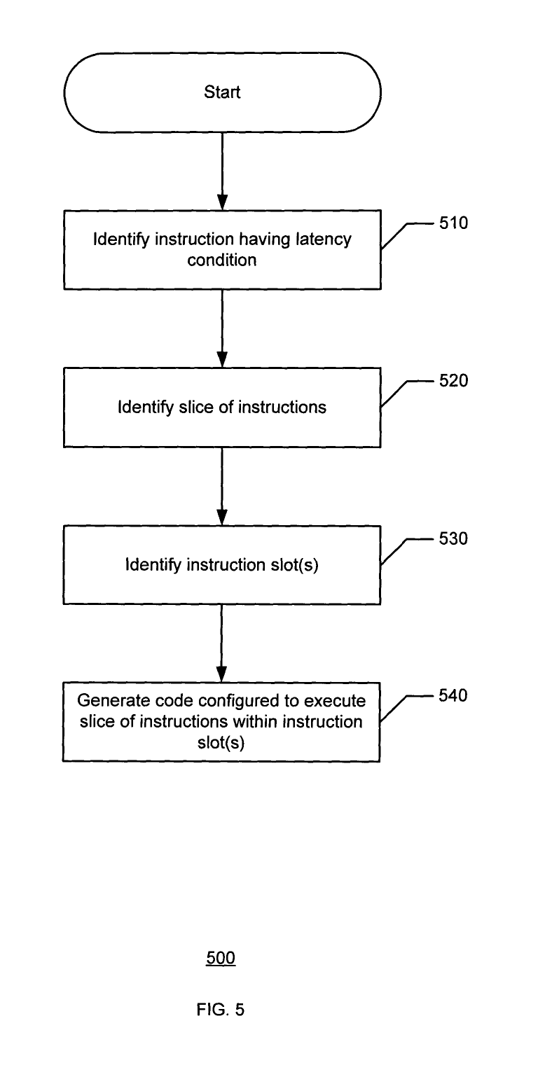

Machine readable instructions that may be executed by the processor system 100 (e.g., via the processor 120) are illustrated in FIG. 5. Persons of ordinary skill in the art will appreciate that the instructions can be implemented in any of many different ways utilizing any of many different programming codes stored on any of many computer-readable media such as a volatile or nonvolatile memory or other mass storage device (e.g., a floppy disk, a CD, and a DVD). For example, the machine readable instructions may be embodied in a machine-readable medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of actions is illustrated in FIG. 5, persons of ordinary skill in the art will appreciate that these actions can be performed in other temporal sequences. Again, the flow chart 500 is merely provided as an example of one way to program the processor system 100 to pre-execute instructions on a single thread.

In the example of FIG. 5, the processor 120 identifies an instruction associated with a latency condition from an original set of code (i.e., the latency instruction) (block 510). For example, the latency instruction may be a load instruction associated with cache misses, which are requests to read from memory that cannot be satisfied by the cache. Accordingly, the main memory is consulted to address the requests. The processor 120 may use load latency information gathered by the performance counter 280 to determine whether the load instruction is associated with cache misses. Alternatively, the processor 120 may use load-latency profiling based on simulations to gather performance statistics on the frequency of cache misses when the load instruction is executed. Persons of ordinary skill in the art will appreciate that static compiler analysis may be used to identify load instructions associated with cache misses by inspecting program structure of the original set of code.

The processor 120 also identifies one or more instructions configured to generate a data address associated with the latency instruction (i.e., a slice of instructions) (block 520). In the slice of instructions, the processor 120 includes instructions within a loop associated with the latency instruction until an instruction associated with an induction variable (e.g., i=i+1) or a recurrent load (e.g., p=p→next) is identified. Alternatively, the processor 120 includes instructions from within the loop until an instruction associated with a loop invariant register (i.e., a register that is constant within the loop) is identified.

The processor 120 then identifies at least one instruction slot within the loop to insert code configured to execute the slice of instructions (i.e., pre-execution code) (block 530). For example, the processor 120 may identify no ops within the loop and replace the no ops with the pre-execution code. The processor 120 generates the pre-execution code within the at least one instruction slot (block 540). In particular, the processor 120 generates code to include instructions with different registers so that register values (e.g., data addresses) in registers associated with the original set of code are not corrupted. Further, a speculative load (e.g., ld.s) or a pre-fetch (e.g., 1fetch) instruction corresponding to a load instruction may be generated based on whether the load result of a load instruction in the slice is required to continue the pre-execution. Thus, the processor 120 may pre-fetch the data address associated with the latency instruction on a single thread.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method to pre-execute instructions comprising:
identifying at least one instruction associated with a latency condition;
identifying a slice of instructions configured to generate a data address associated with the at least one instruction;
identifying at least one instruction slot in a single thread; and
generating code configured to execute the slice of instructions within the at least one instruction slot.

2. A method as defined in claim 1, wherein identifying at least one instruction associated with the latency condition comprises identifying at least one instruction associated with a cache miss.

3. A method as defined in claim 1, wherein identifying the at least one instruction associated with the latency condition comprises identifying at least one load instruction associated with at least one of a loop induction variable, and a recurrent load.

4. A method as defined in claim 1, wherein identifying the at least one instruction associated with the latency condition comprises identifying at least one of an innermost loop and an outer loop associated with the at least one instruction.

5. A method as defined in claim 1, wherein identifying the slice of instructions comprises identifying at least one instruction associated with a data address originating from at least one of a loop induction variable, a recurrent load, and a loop invariant register.

6. A method as defined in claim 1, wherein identifying the at least one instruction slot comprises identifying at least one of an instruction indicative of no operation and a stalled cycle.

7. A method as defined in claim 1, wherein generating code configured to execute the slice of instructions comprises generating at least one of a speculative load instruction and a pre-fetch instruction corresponding to a load instruction.

8. A method as defined in claim 1, wherein generating code configured to execute the slice of instructions comprises generating an instruction associated with at least one of an induction variable and a recurrent load including a pre-execution distance.

9. A machine readable medium storing instructions, which when executed, cause a machine to:
identify at least one instruction associated with a latency condition;
identify a slice of instructions configured to generate a data address associated with the at least one instruction;
identify at least one instruction slot; and
generate code configured to execute the slice of instructions within the at least one instruction slot.

10. A machine readable medium as defined in claim 9, wherein the instructions cause the machine to identify at least one instruction associated with the latency condition by identifying at least one instruction associated with a cache miss.

11. A machine readable medium as defined in claim 9, wherein the instructions cause the machine to identify the at least one instruction associated with the latency condition by identifying at least one load instruction associated with at least one of a loop induction variable and a recurrent load.

12. A machine readable medium as defined in claim 9, wherein the instructions cause the machine to identify the slice of instructions by identifying at least one instruction associated with a data address originating from at least one of a loop induction variable, a recurrent load, and a loop invariant register.

13. A machine readable medium as defined in claim 9, wherein the instructions cause the machine to identify the at least one instruction slot by identifying at least one of an instruction indicative of no operation and a stalled cycle.

14. A machine readable medium as defined in claim 9, wherein the instructions cause the machine to generate code configured to execute the slice of instructions by generating at least one of a speculative load instruction and a pre-fetch instruction corresponding to a load instruction.

15. A machine readable medium as defined in claim 9, wherein the instructions cause the machine to generate code configured to execute the slice of instructions by generating an instruction associated with at least one of an induction variable and a recurrent load including a pre-execution distance.

16. A machine readable medium as defined in claim 9, wherein the machine readable medium comprises one of a programmable gate array, application specific integrated circuit, erasable programmable read only memory, read only memory, random access memory, magnetic media, and optical media.

17. An apparatus to pre-execute instructions comprising:
an instruction identifier configured to identify at least one instruction associated with a latency condition;
a slice identifier configured to identify a slice of instructions configured to generate a data address associated with the at least one instruction;
a slot identifier configured to identify at least one instruction slot in a single thread; and
a code generator configured to generate code to execute the slice of instructions within the at least one instruction slot.

18. An apparatus as defined in claim 17, wherein the at least one instruction associated with the latency condition comprises an instruction associated with a cache miss.

19. An apparatus as defined in claim 17, wherein the at least one instruction associated with the latency condition comprises a load instruction associated with at least one of a loop induction variable and a recurrent load.

20. An apparatus as defined in claim 17, wherein the slice of instructions comprises at least one instruction associated with a data address originating from at least one of a loop induction variable, a recurrent load, and a loop invariant register.

21. An apparatus as defined in claim 17, wherein the at least one instruction slot comprises at least one of an instruction indicative of no operation and a stalled cycle.

22. An apparatus as defined in claim 17, wherein the code to execute the slice of instructions comprises at least one of a speculative load instruction and a pre-fetch instruction corresponding to a load instruction.

23. An apparatus as defined in claim 17, wherein the code configured to execute the slice of instructions comprises an instruction associated with at least one of an induction variable and a recurrent load including a pre-execution distance.

24. A processor system to pre-execute instructions on a single thread comprising:
a dynamic random access memory (DRAM); and
a processor operatively coupled to the DRAM, the processor being programmed to identify at least one instruction associated with a latency condition, to identify a slice of instructions configured to generate a data address associated with the at least one instruction, to identify at least one instruction slot in a single thread, and to generate code configured to execute the slice of instructions within the at least one instruction slot.

25. A processor system as defined in claim 24, wherein the at least one instruction associated with the latency condition comprises an instruction associated with a cache miss.

26. A processor system as defined in claim 24, wherein the at least one instruction associated with the latency condition comprises a load instruction associated with at least one of a loop induction variable and a recurrent load.

27. A processor system as defined in claim 24, wherein the slice of instructions comprises at least one instruction associated with a data address originating from at least one of a loop induction variable, a recurrent load, and a loop invariant register.

28. A processor system as defined in claim 24, wherein the at least one instruction slot comprises at least one of an instruction indicative of no operation and a stalled cycle.

29. A processor system as defined in claim 24, wherein the code configured to execute the slice of instructions comprises at least one of a speculative load instruction and a pre-fetch instruction corresponding to a load instruction.

30. A processor system as defined in claim 24, wherein the code configured to execute the slice of instructions comprises an instruction associated with at least one of an induction variable and a recurrent load including a pre-execution distance.
